(19) United States
(12) Patent Application Publication
(10) Pub. No.: US 2026/0046163 A1
(43) Pub. Date: Feb. 12, 2026

(54) HYBRID FIBER-COAXIAL (HFC) NETWORK DEVICE TRANSPONDER AND SYSTEM FOR BI-DIRECTIONAL COMMUNICATIONS BETWEEN HFC NETWORK DEVICES

(71) Applicant: Applied Optoelectronics, Inc., Sugar Land, TX (US)

(72) Inventors: Ramesh Nallur, Duluth, GA (US); Rafael Celedon, Atlanta, GA (US); Yi Wang, Katy, TX (US)

(21) Appl. No.: 19/294,721

(22) Filed: Aug. 8, 2025

Related U.S. Application Data
(60) Provisional application No. 63/681,560, filed on Aug. 9, 2024.

(51) Int. Cl. H04L 12/28

(52) U.S. Cl. CPC H04L 12/2801

(57) ABSTRACT

An HFC network device transponder provides low data rate, low power, bi-directional transmissions between HFC network devices, such as RF amplifiers, in an HFC network. The HFC network device transponder may provide switching to allow bi-directional transmissions over either upstream or downstream signal channels, which enables direct communication with other HFC network device transponders without using a headend. In some embodiments, the HFC network device transponder may be configured to provide bi-directional transmissions using a LoRaWAN® based packet mode and/or a SCTE 25-1 based serial mode.

### CROSS-REFERENCE TO RELATED APPLICATIONS

This application claims the benefit of U.S. Provisional Patent Application Ser. No. 63/681,560 filed on Aug. 9, 2024, which is fully incorporated herein by reference.

### TECHNICAL FIELD

The present application relates generally to hybrid fiber-coaxial (HFC) networks and, more particularly, to an HFC network device transponder and system for bi-directional communications between HFC network devices.

### BACKGROUND

Broadband communication networks are used to provide high speed, high bandwidth transmissions over communication paths to and from devices in the network. In some broadband networks, such as hybrid fiber-coaxial (HFC) networks used for CATV, at least a portion of the communication path includes a physical communication medium coupled to a plurality of network devices. The physical communication medium may include coaxial cables that carry both downstream and upstream radio frequency (RF) signals. In a CATV network, for example, the downstream RF signals may include video and IP data transmitted from a headend of the HFC network to subscriber devices and the upstream RF signals may include control and IP data transmitted from subscriber devices to the headend. In such broadband networks, there is often a desire to transmit additional information, such as control or status data, to and from devices in the network, for example, to have a more resilient and reliable broadband network and to be able to perform preemptive strategic maintenance to avoid outages. One challenge has been to transmit this additional information to and from devices in the network without interfering with the other RF signals, for example, including the video and IP data.

In an HFC network, for example, the coaxial distribution network may include RF amplifiers to extend the transmission distance of the RF signals and thus extend the reach of the CATV services provided to subscriber locations. Providing bidirectional communication with or between the RF amplifiers in the HFC network is desirable, for example, for purposes of remotely controlling and/or monitoring the RF amplifiers.

### SUMMARY

Consistent with an aspect of the present disclosure, an apparatus is provided for low data rate, low power bidirectional transmissions in a hybrid fiber-coaxial (HFC) network. The apparatus includes a host interface configured to provide an interface with circuitry in a host HFC network device, a downstream input configured to connect to a downstream signal path in the host network device, and an upstream output configured to connect to an upstream signal path in the host network device. The apparatus also includes at least one transceiver coupled to the host interface and coupled to the downstream input and the upstream output and a switching system. The switching system is configured to route receive signals for the low data rate, low power bidirectional transmissions to the least one transceiver from either the downstream input or the upstream output and configured to route transmit signals for the low data rate, low power bidirectional transmissions from the least one transceiver to either the downstream input or the upstream output.

Consistent with another aspect of the present disclosure, a system is provided for bi-directional communication in a hybrid fiber-coaxial (HFC) network. The system includes at least first and second HFC network devices coupled to a coaxial cable distribution network that provides downstream primary signals and upstream primary signals over downstream signal channels and upstream signal channels, respectively. The at least first and second HFC network devices are configured to communicate with each other directly using low data rate, low power bidirectional transmissions. Each of the at least first and second HFC network devices includes a transponder, and the transponder includes a host interface configured to provide an interface with HFC network device circuitry, a downstream input configured to connect to a downstream signal path in the host network device, and an upstream output configured to connect to an upstream signal path in the host network device. The transponder also includes at least one transceiver coupled to the host interface and coupled to the downstream input and the upstream output and a switching system. The switching system is configured to route receive signals for the low data rate, low power bidirectional transmissions to the least one transceiver from either the downstream input or the upstream output and configured to route transmit signals for the low data rate, low power bidirectional transmissions from the least one transceiver to either the downstream input or the upstream output.

Consistent with a further aspect of the present disclosure, an apparatus is provided for low data rate, low power bidirectional transmissions in a hybrid fiber-coaxial (HFC) network. The apparatus includes a host interface configured to provide an interface with circuitry in a host HFC network device, a downstream input configured to connect to a downstream signal path in the host network device, and an upstream output configured to connect to an upstream signal path in the host network device. The apparatus also includes at least one transceiver coupled to the host interface and coupled to the downstream input and the upstream output. The at least one transceiver is configured for low data rate, low power bidirectional transmissions using a LoRaWAN® based packet mode and an SCTE 25-1 based serial mode.

### BRIEF DESCRIPTION OF THE DRAWINGS

Reference should be made to the following detailed description which should be read in conjunction with the following figures, wherein like numerals represent like parts.

FIG. 1 is a schematic diagram of a hybrid fiber-coaxial (HFC) network used for CATV, consistent with the present disclosure.

FIG. 2 is a schematic diagram of a traditional HFC network configured for low data rate, low power, bidirectional transmissions between network devices and a headend, consistent with the present disclosure.

FIG. 3 is a schematic diagram of a remote PHY (R-PHY) HFC network configured for low data rate, low power, bidirectional transmissions between network devices and a headend, consistent with the present disclosure.

FIG. 4 is a schematic diagram of a gateway device for use in a headend of the HFC network to provide low data rate, low power, bidirectional transmissions, consistent with embodiments of the present disclosure.

FIG. 5 is a schematic diagram of an RF amplifier including electronic amplifier circuitry and a transponder for low data rate, low power, bidirectional transmissions, consistent with embodiments of the present disclosure.

FIG. 6 is a schematic diagram of an embodiment of an HFC network device transponder with dual out-of-band communications, consistent with the present disclosure.

FIG. 7 is a schematic diagram of another embodiment of an HFC network device transponder configured to communicate bidirectionally with other HFC network device transponders, consistent with the present disclosure.

### DETAILED DESCRIPTION

An HFC network device transponder, consistent with embodiments of the present disclosure, provides low data rate, low power, bi-directional transmissions between HFC network devices, such as RF amplifiers, in an HFC network. The HFC network device transponder may provide switching to allow bi-directional transmissions over either upstream or downstream signal channels, which enables direct communication with other HFC network device transponders without using a headend. In some embodiments, the HFC network device transponder may be configured to provide bi-directional transmissions using a LoRaWAN® based packet mode and/or a SCTE 25-1 based serial mode.

Low data rate, low power, bi-directional transmissions may be provided over existing physical communication media (e.g., coaxial cables and/or optical fiber) and in the presence of higher bandwidth, higher power primary signals currently being transmitted over the communication media. The low data rate, low power, bi-directional transmissions may be accomplished using modulated signals that are positioned in frequency relative to the primary signals, such that the low data rate, low power transmissions occur without detectable interference with the primary signals, which include multiplexed narrowband modulated signals.

In some embodiments, the primary signals may be modulated using quadrature amplitude modulation (QAM) and multiplexed using orthogonal frequency division multiplexing (OFDM). Low data rate, low power transmissions may be spread-spectrum modulated signals, such as chirp spread spectrum (CSS) modulated signals modulated using Gaussian frequency shift keying (GFSK). One example of the spread-spectrum modulated signals is implemented using LoRa technology and communication protocols defined by the LoRaWAN® standard. Low data rate, low power transmissions may also be frequency shift keying (FSK) modulated signals implemented using the SCTE 25-1 hardware specification. Communication via the SCTE 25-1 hardware specification is defined in the ANSI/SCTE 25-1 2017 (R2022) specification by the American National Standards Institute, which covers Hybrid Fiber Coax Outside Plant Status Monitoring—Physical (PHY) Layer.

As used herein, “channel” refers to a sub-range of frequencies within a spectrum of frequencies, which are capable of being modulated to carry information. A “channel” may be identified as a single frequency in the sub-range of frequencies, and as used herein, “selecting a channel” may include selecting a single frequency that identifies the channel. As used herein, “primary communication channel” refers to a channel in a defined telecommunications frequency band (e.g., a CATV channel) and a “primary signal” refers to a signal transmitted using a primary communication channel. As used herein, a “downstream primary signal” (also referred to as a forward primary signal) is primary signal being sent from a source, such as a CATV headend/hub, to a destination, such as a CATV subscriber and an “upstream primary signal” (also referred to as a reverse primary signal) is a primary signal being sent from a destination, such as the CATV subscriber, to a source, such as the CATV headend/hub. As used herein, “channel spectrum” refers to a predefined range of radio frequencies divided into a plurality of sub-ranges of frequencies (referred to as physical channels) and capable of being modulated to carry information. A “CATV channel spectrum” is a channel spectrum used for delivering video and/or data in a CATV network and is not limited to a particular range of frequencies.

As used herein, “low data rate” refers to a data rate that is lower than the data rate of the primary signals on the primary communication channels and “low power” refers to a signal power that is lower than the signal power of the primary signals on the primary communication channels. For example, the “low data rate” may be in the range of 5 kbps to 100 kbps and the “low power” may be between −10 dBm and 0 dBm. As used herein, “LoRaWAN® based packet mode” refers to a mode of communication using data packets generated in accordance with the communication protocols defined by the LoRaWAN® standard. As used herein, “SCTE 25-1 based serial mode” refers to a mode of serial communication using a UART-type protocol in accordance with the SCTE 25-1 standard.

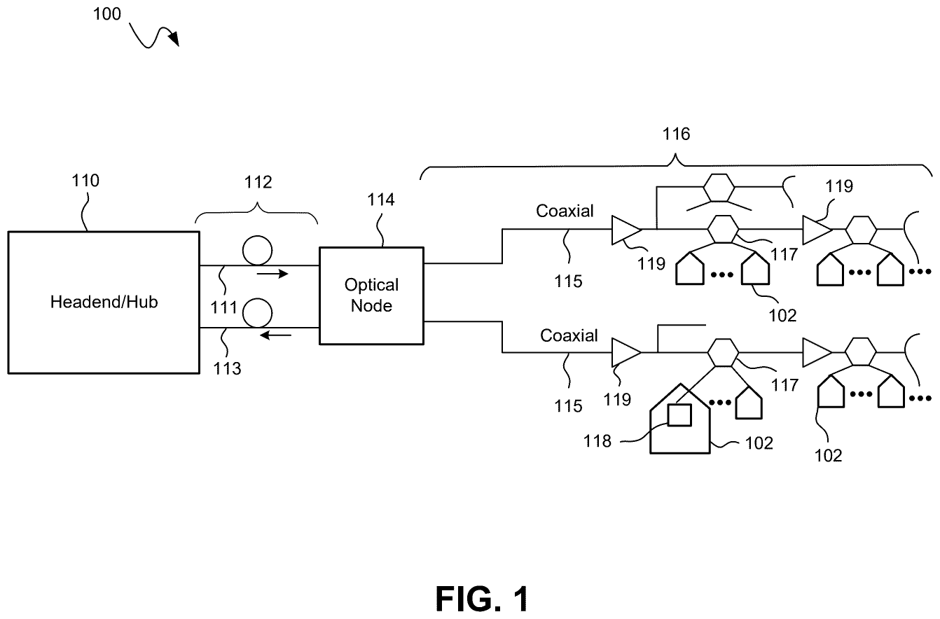

FIG. 1 illustrates an example of a hybrid fiber-coaxial (HFC) network 100 used for CATV, which may implement low data rate, low power, bidirectional transmissions with or between HFC network devices, consistent with embodiments of the present disclosure. The low data rate, low power, bidirectional transmissions may be implemented, for example, to communicate with or between a node 114 and/or line extender RF amplifiers 119 in the HFC network 100, as described in greater detail below. In general, the HFC network 100 is capable of delivering both cable television programming (i.e., video) and IP data services (e.g., internet and voice over IP) to customers or subscribers 102 through the same fiber optic cables and coaxial cables (i.e., trunk lines). Such an HFC network 100 is commonly used by service providers, such as Comcast Corporation, to provide combined video, voice, and broadband internet services to the subscribers 102. Although example embodiments of HFC networks are described herein based on various standards (e.g., Data over Cable Service Interface Specification or DOCSIS), the concepts described herein may be applicable to other embodiments of CATV networks using other standards.

Multiple cable television channels and IP data services (e.g., broadband internet and voice over IP) may be delivered together simultaneously in the CATV network 100 by transmitting signals using frequency division multiplexing over a plurality of physical channels across a CATV channel spectrum. One example of the CATV downstream channel spectrum (also referred to as forward spectrum) includes channels from 650 MHz to 1794 MHz, but the CATV channel spectrum may be expanded even further to increase bandwidth for data transmission. In a CATV channel spectrum, some of the physical channels may be allocated for cable television channels and other physical channels may be allocated for IP data services. Other channel spectrums and bandwidths may also be used and are within the scope of the present disclosure.

In addition to the primary signals being carried downstream (also referred to as forward signals) to deliver the video and IP data to the subscribers 102, the HFC network 100 may also carry primary signals (e.g., IP data or control signals) upstream from the subscribers (also referred to as reverse signals), thereby providing bidirectional communication over the trunks. According to one example, the signal spectrum for the reverse signals carried upstream may be up to 600 MHz.

The HFC network 100 generally includes a headend/hub 110 connected via optical fiber trunk lines 112 to one or more optical nodes 114, which are connected via a coaxial cable distribution network 116 to customer premises equipment (CPE) 118 at subscriber locations 102. The headend/hub 110 receives, processes, and combines the content (e.g., broadcast video, narrowcast video, and internet data) to be carried over the optical fiber trunk lines 112 as optical signals. The optical fiber trunk lines 112 include forward path optical fibers 111 for carrying downstream optical signals from the headend/hub 110 and return or reverse path optical fibers 113 for carrying upstream optical signals to the headend/hub 110. The optical nodes 114 provide an optical-to-electrical interface between the optical fiber trunk lines 112 and the coaxial cable distribution network 116. The optical nodes 114 thus receive downstream optical signals and transmit upstream optical signals and transmit downstream (forward) RF electrical signals and receive upstream (reverse) RF electrical signals.

The cable distribution network 116 includes coaxial cables 115 including trunk coaxial cables connected to the optical node(s) 114 and feeder coaxial cables connected to the trunk coaxial cables. Subscriber drop coaxial cables are connected to the distribution coaxial cables using taps 117 and are connected to customer premises equipment 118 at the subscriber locations 102. The customer premises equipment 118 may include set-top boxes for video and cable modems for data. One or more line extender RF amplifiers 119 may also be coupled to the coaxial cables 116 for amplifying the forward signals (e.g., CATV signals) being carried downstream to the subscribers 102 and for amplifying the reverse signals being carried upstream from the subscribers 102. In this embodiment, as will be described in greater detail below, the optical node 114 and/or the line extender RF amplifiers 119 may include transponders and the headend/hub 110 may include a gateway device and/or headend element to implement the low data rate, low power, bidirectional transmissions together with the downstream and upstream primary signals, which have a higher bandwidth and power.

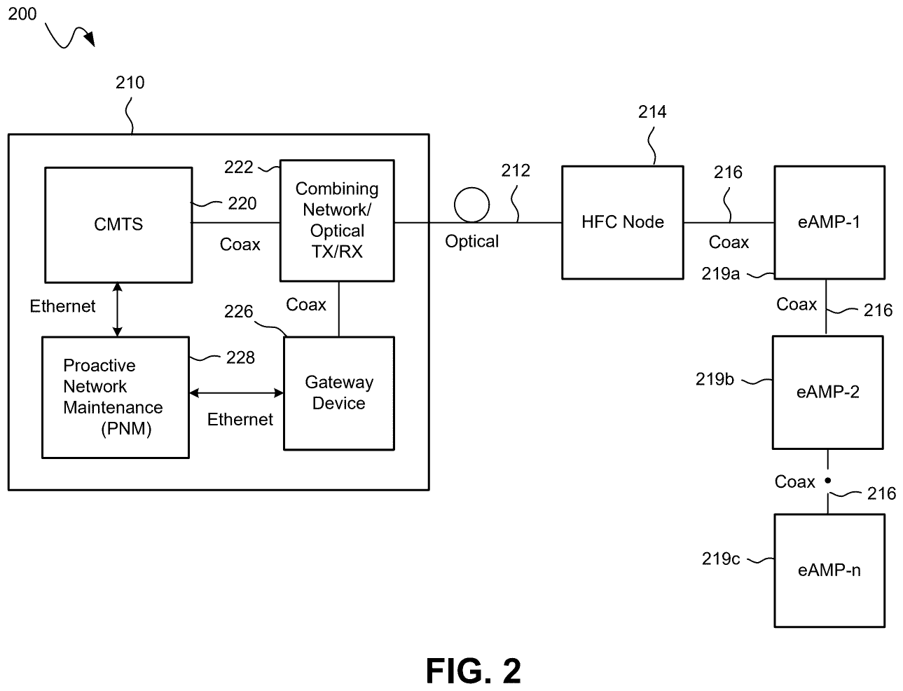

FIG. 2 shows an implementation of a system for low data rate, low power, bidirectional transmissions in a traditional HFC network 200, consistent with an embodiment. This embodiment of the HFC network 200 includes a headend 210 coupled to an HFC node 214 using optical fiber 212 and includes RF amplifiers 219a-c coupled to the HFC node 214 using coaxial cables 216, similar to the HFC network 100 described above and shown in FIG. 1. In this embodiment of the HFC network 200, analog communication is provided over the optical fiber 212 between the headend 210 and the HFC node 214.

In this embodiment of the HFC network 200, the headend 210 includes a cable modem termination system (CMTS) 220 coupled to a combining network and optical transmitters and receivers (collectively referred to as Combining Network/Optical TX/RX 222). The CMTS 220 provides the MAC and PHY layer connection to the cable modems at subscriber locations (not shown in FIG. 2) for transmitting downstream primary signals to the subscribers and receiving upstream primary signals from the subscribers. The optical transmitters and receivers in the Combining Network/Optical TX/RX 222 transmit and receive analog optical signals over the optical fiber 212, and the combining network in the Combining Network/Optical TX/RX 222 combines and separates signals that are transmitted and received by the optical transmitters and receivers.

To establish low data rate, low power bidirectional transmissions, the headend 210 also includes a gateway device 226, which may be implemented as a shelf in the headend 210, coupled to the Combining Network/Optical TX/RX 222. In this embodiment, the low data rate, low power bidirectional transmissions may be combined with the analog downstream and upstream primary signals in the combining network and transmitted and received by the optical transmitters and receivers. The node 214 and/or RF amplifiers 219a-c may include transponders (not shown in FIG. 2) for establishing the low data rate, low power bidirectional transmissions with the gateway device 226, as will be described in greater detail below.

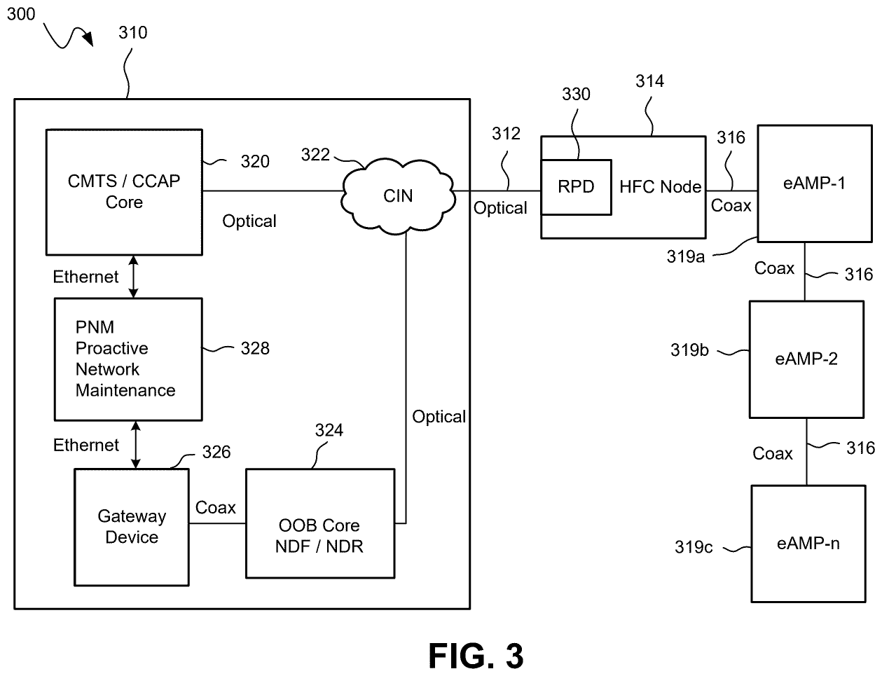

FIG. 3 shows an implementation of a system for low data rate, low power, bidirectional transmissions in a remote PHY type HFC network 300, consistent with another embodiment. This embodiment of the HFC network 300 also includes a headend 310 coupled to an HFC node 314 using optical fiber 312 and includes RF amplifiers 319a-c coupled to the HFC node 314 using coaxial cables 316, similar to the HFC network 100 described above and shown in FIG. 1. In this embodiment of the HFC network 300, digital communication is provided over the optical fiber 312 between the headend 310 and the HFC node 314, and the HFC node 314 includes a remote PHY device (RPD) 330 to handle the digital communications.

In this embodiment of the HFC network 300, the headend 310 includes an integrated CMTS or Converged Cable Access Platform (CCAP) core 320 coupled to a converged interconnected network (CIN) 322. The CCAP core 320 and the CIN 322 provide digitized optical communication with the RPD 330 in the HFC node 314. The headend 310 also includes a gateway device 326 to establish low data rate, low power bidirectional transmissions. In this embodiment, the analog low data rate, low power bidirectional transmissions are digitized for communication between the CIN 322 and the RPD 330 in the HFC node 314. The RPD 330 converts upstream signals from analog to digital and converts downstream signals from digital to analog, and the headend 310 may include an out-of-band (OOB) core 324 coupled to the gateway device 326 to handle the A/D and D/A conversion in the headend 310 for the low data rate, low power bidirectional transmissions.

The OOB core 324 may use known technologies and standards in the DOCSIS R-PHY specifications referred to as the OOB (out-of-band) communication protocols, which are further defined in the remote out-of-band (CM-SP-R-OOB) specification. As defined in the CM-SP-R-OOB specification, Narrowband Digital Forward (NDF) and Narrowband Digital Return (NDR) digitizes a small portion of the spectrum and sends the digital samples as payload within packets that traverse between the CMTS/CCAP core 320 and the RPD 330. This approach works with any type of OOB signal as long as the signal can be contained within the defined pass bands.

In both embodiments of the HFC network 200, 300 described above, the headend 210, 310 may also be configured to communicate with network elements, such as the RF amplifiers 219a-c, 319a-c, in accordance with Hybrid Management Sub-Layer (HMS) specifications developed for monitoring and/or managing HFC network elements. In accordance with HMS specifications, the headend 210, 310 may include a headend element to communicate with HMS-compliant transponders located, for example, in the RF amplifiers 219a-c, 319a-c.

In both embodiments of the HFC network 200, 300 described above, the headend 210, 310 may include a proactive network maintenance (PNM) system 228, 328 coupled to the CMTS 220, 320 and the gateway device 226, 326. The PNM system 228, 328 may be used by cable operators to perform strategic maintenance of a network preemptively to avoid long outages and to have a more resilient and reliable broadband network. Commands and/or data used by the PNM system 228, 328 may be transmitted and received via the low data rate, low power bidirectional transmissions established using the gateway device 226, 326 to provide network maintenance. The PNM system 228, 328 may include existing PNM systems known to those skilled in the art.

The headend 210, 310 may use the gateway device 226, 326 and/or a headend element to provide the low data rate, low power bidirectional transmissions to communicate the commands and/or data for managing a large number of network devices, such as nodes and RF amplifiers, in the HFC network 200, 300 using existing network management and control systems. The systems and methods for low data rate, low power bidirectional transmissions, consistent with embodiments of the present disclosure, thus provide a relatively simple, reliable, and low cost solution for monitoring, controlling, and managing broadband networks without detectable interference with the primary broadband signals.

In the embodiments of the HFC networks 100, 200, 300 described above, one type of low data rate, low power bidirectional transmissions may use spread-spectrum modulated signals that are positioned in frequency relative to the primary signals (e.g., multiplexed narrowband modulated signals), such that the low data rate, low power transmissions occur without detectable interference with the primary signals. The spread-spectrum signals may be transmitted with downstream primary signals, for example, at frequencies between 150 MHz to 960 MHz and with upstream primary signals, for example, at frequencies between 5 MHz to 85 MHz. The spread-spectrum modulated signals may be chirp spread spectrum (CSS) modulated signals modulated using Gaussian frequency shift keying (GFSK). GFSK modulation may be used at fixed frequencies with bandwidths up to 500 kHz, and the spread spectrum bandwidths may be from 7 kHz to 500 kHz. The use of spread spectrum technology reduces the chance of interference with or being interfered by other signals (e.g., primary downstream and upstream signals). One example of the spread-spectrum modulated signals is implemented using LoRa technology and communication protocols defined by the LoRaWAN® standard.

In the embodiments of the HFC networks 100, 200, 300 described above, another type of low data rate, low power bidirectional transmissions may use frequency shift keying (FSK) modulated signals. One example of the FSK modulated signals is implemented using the SCTE 25-1 standard defining the physical layer portion of the protocol stack used for communication between a headend element and HMS-compliant transponders.

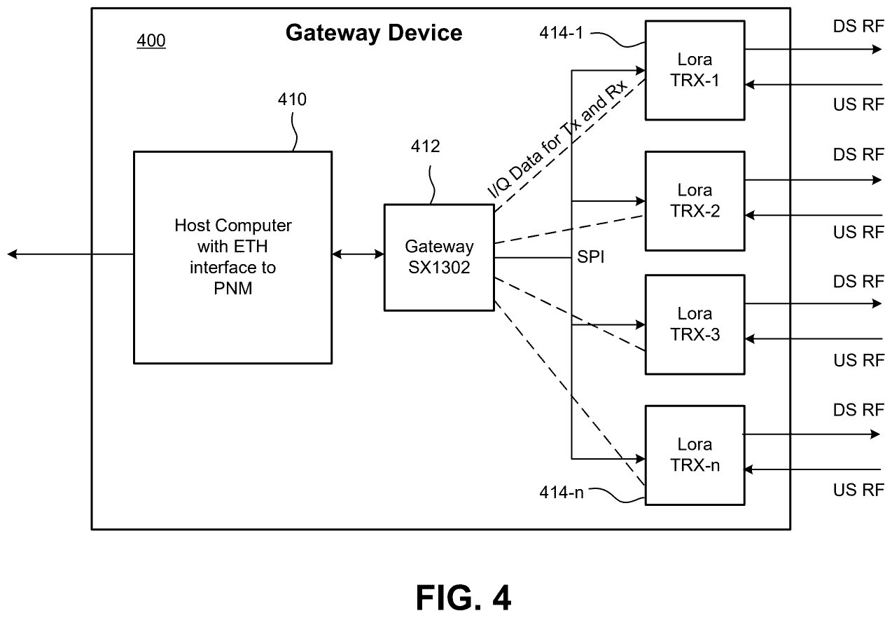

Referring to FIG. 4, an embodiment of a gateway device 400 that may be used for the gateway devices 226, 326 in HFC networks 200, 300 is described in greater detail. In this embodiment, the gateway device 400 includes a host computer 410 that provides a data interface (e.g., ethernet) to the PNM system or other type of system or application server in the headend. A gateway processor 412 (e.g., a LoRa gateway processor) is coupled to the host computer 410 and a plurality of gateway transceivers 414-1 to 414-n (e.g., LoRa transceivers) are coupled to the gateway processor 412 for transmitting and receiving the spread-spectrum signals as downstream RF signals (DS RF) and upstream RF signals (US RF). The gateway processor 412 may be coupled to the transceivers 414-1 to 414-n using a serial peripheral interface (SPI).

The gateway processor 412 modulates data from the host computer 410 and provides I/Q data to the gateway transceivers 414-1 to 414-n for the downstream RF signals (DS RF). The gateway processor 412 also receives I/Q data from the gateway transceivers 414-1 to 414-n for the upstream RF signals (US RF) and demodulates the data. As discussed above, the downstream (DS RF) and upstream (US RF) spread-spectrum RF signals from and to the gateway transceivers 414-1 to 414-n may be transmitted and received with the downstream and upstream primary signals via the combining network/optical TX/RX 222 in the HFC network 200 (see FIG. 2) or via the OOB core 324 in the HFC network 300 (see FIG. 3).

Where LoRa technology is used for the low data rate, low power bidirectional transmissions, the host computer 410, the gateway processor 412 and the gateway transceivers 414-1 to 414-n operate in accordance with the LoRa network architecture, protocols and frame format. In an embodiment where the host computer 410 is connected to a PNM system (e.g., PNM systems 228, 328), the host computer 410 translates PNM commands and data to Lora TCP/IP commands and data. One example of the gateway processor 412 is the LoRa gateway baseband processor SX1302 available from Semtech Corporation and one example of the gateway transceivers 414-1 to 414-n are LoRa transceivers available from Semtech Corporation.

In other embodiments, a headend virtual gateway may be used for providing the low data rate, low power bidirectional transmissions, for example, in accordance with the LoRa network architecture, protocols and frame format. The headend virtual gateway may be implemented in software and may replace a hardware gateway device in the headend. In further embodiments, a portable network communications module may be connected directly to an HFC node (e.g., HFC node 314) for providing the low data rate, low power bidirectional transmissions, for example, in accordance with the LoRa network architecture, protocols and frame format. The portable network communications module may be configured similar to the gateway device 400 with a computing device, a gateway processor, and at least one gateway transceiver.

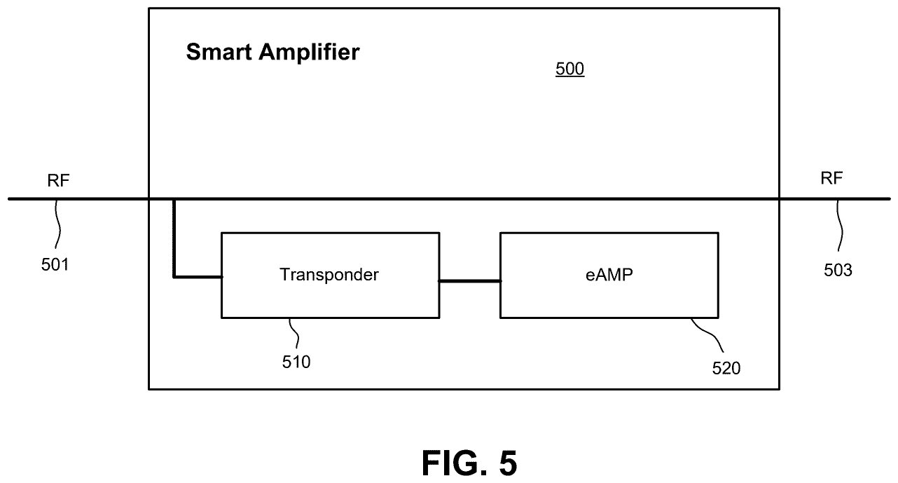

As shown in FIG. 5, an RF amplifier 500 (e.g., RF amplifiers 219a-c in HFC network 200 or RF amplifiers 319a-c in HFC network 300) may include a transponder 510 together with the electronic amplifier circuitry (eAMP) 520, consistent with embodiments of the present disclosure. The transponder 510 provides low data rate, low power, bidirectional transmissions with a headend element and/or a gateway device in a headend (e.g., gateway devices 226, 326 in the headends 210, 310), for example, to send data signals from the amplifier 500 to the headend and/or to receive control signals from the headend in the amplifier 500. The transponder 510 provides the low data rate, low power, bidirectional transmissions together with the upstream and downstream primary signals over the coaxial cables 501, 503 coupled to the RF amplifier 500. Upstream and downstream channels carried over the coaxial cables 501, 503 may be separated inside the RF amplifier 500 on an upstream signal path and a downstream signal path. The downstream and upstream signal paths may be coupled to diplexers in the RF amplifier for separating and combining the downstream and upstream channels, which are carried together over the coaxial cables 501, 503. The transponder 510 may also provide bidirectional transmissions with other transponders located in other amplifiers or network devices in the HFC network without using the headend or a gateway, as will be described in greater detail below.

Similar to the transceivers 400-1 to 400-n in the gateway device 400, the transponder 510 may use spread-spectrum modulated RF signals, such as CSS modulated signals or LoRa signals, to provide the low data rate, low power, bidirectional transmissions with the gateway device 400. In particular, the transponder 510 may receive downstream RF signals (DS RF) from the gateway device 400 using a downstream signal channel and may transmit upstream RF signals (DS RF) to the gateway device 400 using an upstream signal channel. By using spread-spectrum modulated signals, such as CSS modulated signals or LoRa signals, the transponder 510 may transmit and receive the RF signals using relatively low power, e.g., consuming less than 1 watt inside of the amplifier 500, which helps manage power consumption and head in the RF amplifier 500. The transponder 510 also provides a robust RF interface, for example, with more than 130 dB of dynamic range and the ability to recover signals up to 20 dB below the average noise.

The transponder 510 may also provide low data rate, low power bidirectional transmissions using SCTE 25-1 signals instead of or in addition to Lora signals, thereby providing dual out-of-band communications. This allows for simultaneous support for both LoRa based packet communication protocol and communications via the SCTE 25-1 hardware specification. The transponder 510 may include separate transceivers for the LoRaWAN® based packet mode and the SCTE 25-1 based serial mode or may include a single transceiver configured for both the LoRaWAN® based packet mode and the SCTE 25-1 based serial mode. In another embodiment, the transponder 510 may be configured to switch the low data rate, low power bidirectional transmissions between upstream and downstream signal channels to facilitate communications directly with other amplifiers or other HFC network devices without using the headend or a gateway, as will be described in greater detail below.

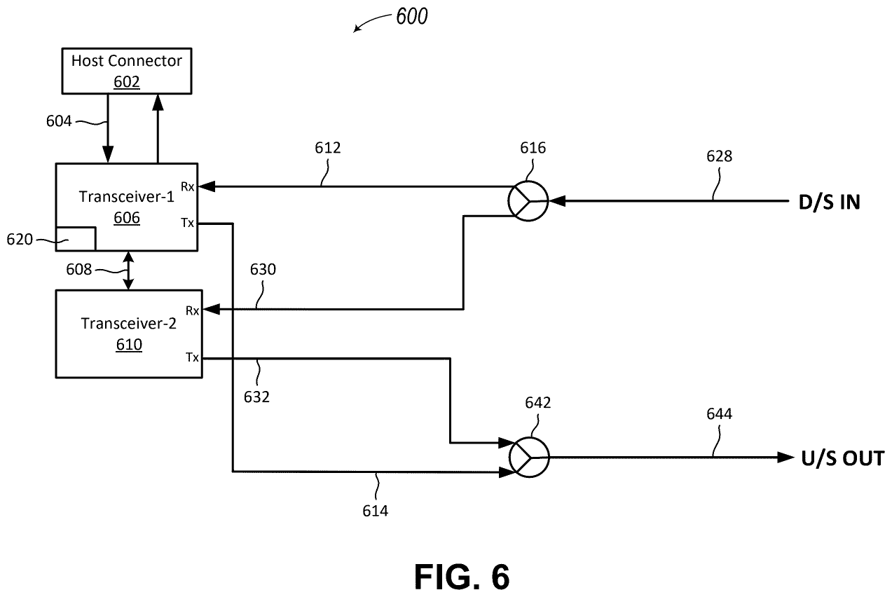

FIG. 6 shows one embodiment of an HFC network device transponder 600, consistent with the present disclosure, configured for dual out-of-band communications. The HFC network device transponder 600 may be used as the transponder 510 in the RF amplifier 500 and may be connected to the amplifier circuitry 520. The transponder 600 includes a downstream input (D/S IN) 628 that may be connected to the downstream signal path in the RF amplifier and an upstream output 644 that may be connected to the upstream signal path in the RF amplifier. The HFC network device transponder 600 may also be used in other HFC network devices.

As shown in FIG. 6, the transponder 600 includes a first transceiver 606 and a second transceiver 610. In an embodiment, the first transceiver 606 and the second transceiver 610 may each be, for example, a LoRa transceiver (i.e., supports the LoRaWAN® based packet mode), a transceiver that complies with the SCTE 25-1 physical layer specification (i.e., supports the SCTE 25-1 based serial mode), or a combination transceiver that supports both the LoRaWAN® based packet mode as well as the SCTE 25-1 based serial mode. It should be noted that each of the first transceiver 606 and the second transceiver 610 may be different transceivers. For example, the first transceiver 606 may be a combination transceiver that supports both the LoRaWAN® based packet mode as well as the SCTE 25-1 based serial mode, while the second transceiver 610 may support only the LoRaWAN® based packet mode. In other embodiments, the first transceiver 606 and the second transceiver 610 may be any combination of transceivers that support the LoRaWAN® based packet mode, the SCTE 25-1 based serial mode, or both.

In this embodiment, the first transceiver 606 is connected to circuitry in the host HFC device (e.g., amplifier circuitry in a host RF amplifier) using a host interface including a host connector 602 and serial communication interface 604, for example, a UART interface. The second transceiver 610 is connected to the first transceiver 606, for example, with a SPI/GPIO (general-purpose input/output) interface 608. It should be noted that this only represents one embodiment of the connection of the first transceiver 606 and the second transceiver 610 to the host circuitry. In another embodiment, the first transceiver 606 and the second transceiver 610 may both be connected to the host connector 602. In other embodiments, the first transceiver 606 and the second transceiver 610 may connect to the host circuitry by any other means as would be known to one skilled in the art.

In this embodiment, the receive input 612 of the first transceiver 606 and the receive input 630 of the second transceiver 610 are both coupled to the downstream input (D/S IN) 628 through splitter 616. The transmit output 614 of the first transceiver 606 and the transmit output 632 of the second transceiver 610 are both coupled to the upstream output (U/S OUT) 644 through combiner 642. Thus, both the first and second transceivers 606, 610 may receive downstream signals via the downstream input 628 and transmit upstream signals via the upstream output 644. In this way, either the first transceiver 606 or the second transceiver 610 may communicate over the upstream and downstream connections. For example, the first transceiver 606 may receive over the downstream input 628 while the second transceiver 610 transmits over the upstream output 644. Alternatively, both transceivers 606, 610 may receive simultaneously over the downstream input 628 or transmit simultaneously over the upstream output 644 by using different frequency channels.

In the illustrated embodiment, the first transceiver 606 includes a controller 620, such as a built-in MCU, which may be configured to determine whether the first transceiver 606 or the second transceiver 610 is used for the OOB communications. The controller 620 may also be configured to determine whether the LoRaWAN® based packet mode or the SCTE 25-1 based serial mode is used for the OOB communications. In another embodiment, the second transceiver 610 may include a controller in addition to or instead of the controller 620 in the first transceiver 606. In a further embodiment, a separate controller may be connected to both the first transceiver 606 and the second transceiver 610. In an embodiment, the controller 620 may receive instructions via the host connector 602 and the serial communication interface 604 for controlling which transceiver is used and which mode is used. The configuration of the transponder 600 may be changed, for example, by the headend and/or by a user connecting to an amplifier or node.

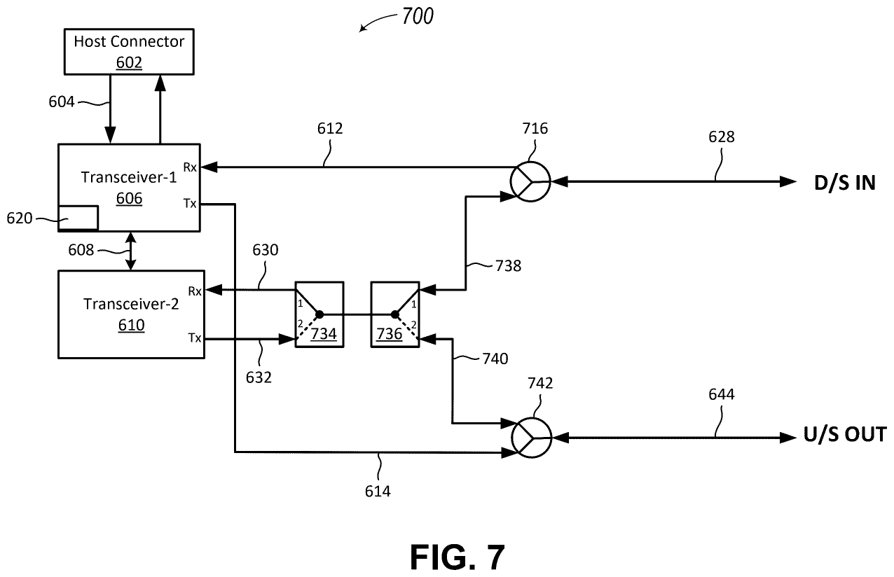

In the embodiment of the HFC network device transponder 600 shown in FIG. 6, the first transceiver 606 and the second transceiver 610 are both configured to receive low data rate, low power signals from a gateway or a headend using downstream channels via the downstream input 628 and configured to transmit low data rate, low power signals to a gateway or a headend using upstream channels via the upstream output 644. FIG. 7 shows another embodiment an HFC network device transponder 700, consistent with embodiments of the present disclosure, configured to transmit and receive on either a downstream signal channel or an upstream signal channel.

Similar to the transponder 600, the HFC network device transponder 700 may be used as the transponder 510 in the RF amplifier 500 and may be connected to the amplifier circuitry 520. The transponder 700 also includes a downstream input (D/S IN) 628 that may be connected to the downstream signal path in the RF amplifier and an upstream output 644 that may be connected to the upstream signal path in the RF amplifier. The HFC network device transponder 700 may also be used in other HFC network devices.

In an HFC network, downstream channels are typically used to transmit signals from the headend to the users and upstream channels are typically used to transmit signals from the users back to the headend, i.e., the information is one way over either the downstream channels or the upstream channels. The transponder 700 includes circuitry to enable routing either transmit signals or receive signals to either the downstream channels or the upstream channels, allowing for bidirectional communication over the downstream channels, the upstream channels, or both the downstream channels and the upstream channels. This embodiment of the HFC network device transponder 700 thus enables bidirectional communication directly between HFC devices without using a headend or gateway.

Similar to the transponder 600 shown in FIG. 6, the first transceiver 606 is connected to circuitry in the host HFC device using a host interface including the host connector 602 and a serial communication interface 604, such as a UART interface, and the second transceiver 610 is connected to the first transceiver 606, for example, via a SPI/GPIO (general-purpose input/output) interface 608. In the embodiment of FIG. 7, the second transceiver 610 has been configured to both transmit and receive over either the downstream channels or upstream channels, while the first transceiver 606 is configured to receive over downstream channels and transmit over upstream channels. To support bidirectional OOB communications, the transponder 700 includes a switching system connected to the receive input 630 and the transmit output 632 of the second transceiver 610. The switching system may be configured to route the receive signals for the OOB communications to the second transceiver 610 from either the downstream input 628 or the upstream output 644, and to route the transmit signals for the OOB communications from the second transceiver 610 to either the downstream input 628 or the upstream output 644.

In the example of FIG. 7, the switching system includes a first switch 734 connected in series to a second switch 736. The first switch 734 switches between the receive and transmit functions of the second transceiver 610, and the second switch 736 switches between the downstream input 628 and the upstream output 644. In an embodiment, the switches 734, 736 may be SPDT (Single Pole Double Throw) switches and may be controlled by software. The receive input 630 of the second transceiver 610 is connected to port 1 of the first switch 734, and the transmit output 632 of the second transceiver 610 is connected to port 2 of the first switch 734. Port 1 of the second switch 736 is connected to the first splitter/combiner 716, and port 2 of the second switch 736 is connected to the second splitter/combiner 742. Unlike the splitter 616 and the combiner 642 in the embodiment of the transponder 600 shown in FIG. 6, the first splitter/combiner 716 and the second splitter/combiner 742 in this embodiment of the transponder 700 both support bidirectional communication.

To support bidirectional communications, the second transceiver 610 may receive over the downstream input (DS IN) 628 by setting the first switch 734 to port 1, thereby selecting the receiver of the second transceiver 610, and setting the second switch 736 to port 1, thereby selecting the first splitter/combiner 716 to route the input from the downstream input (D/S IN) 628. The second transceiver 610 may receive over the upstream output (U/S OUT) 644 by setting the first switch 734 to port 1, thereby selecting the receiver of the second transceiver 610, and setting the second switch 736 to port 2, thereby selecting the second splitter/combiner 742 to route the input from the upstream output (U/S OUT) 644. The second transceiver 610 may transmit over the downstream input (D/S IN) 628 by setting the first switch 734 to port 2, thereby selecting the transmitter of the second transceiver 610, and setting the second switch 736 to port 1, thereby selecting the first splitter/combiner 716 to route the output to the downstream input (D/S IN) 628. The second transceiver 610 may transmit over the upstream output (U/S OUT) 644 by setting the first switch 734 to port 2, thereby selecting the transmitter of the second transceiver 610, and setting the second switch 736 to port 2, thereby selecting the second splitter/combiner 742 to route the output to the upstream output (U/S OUT) 644. The second transceiver 610 may thus be used to transmit or receive over either an upstream signal channel or a downstream signal channel, which allows direct communication with a similar transponder in another HFC device.

The receive input 612 of the first transceiver 606 is coupled to the downstream input (D/S IN) 628 through the first splitter/combiner 716. The transmit output 614 of the first transceiver 606 is coupled to the upstream output (U/S OUT) 644 through the second splitter/combiner 742. In other embodiments, the first transceiver 606 may be configured for bidirectional communication in the same manner as the second transceiver 610 with the addition of two additional switches similar to the first and second switches 734, 736.

Similar to the embodiment of the transponder 600 in FIG. 6, the first transceiver 606 in this embodiment of the transponder 700 includes a controller 620, such as a built-in MCU. In this embodiment, the controller 620 may be configured to control the switching system to determine whether the second transceiver 610 transmits or receives over the downstream input 628 or the upstream output 644. The controller 620 may also be configured to determine whether the first transceiver 606 or the second transceiver 610 is used for the OOB communications. If one of the transceivers 606, 610 is capable of communication using both the LoRaWAN® based packet mode and the SCTE 25-1 based serial mode, the controller 620 may also be configured to control the mode of communication. In other embodiments, the second transceiver 610 may include a controller, or a separate controller may be connected to both the first transceiver 606 and the second transceiver 610. The configuration of the transponder 600 may be changed by the headend and/or by a user connecting to an amplifier or node (e.g., using a portable network communications module) and such a change in configuration may be communicated via the host connector 602 and the serial communication interface 604.

Accordingly, a transponder, consistent with embodiments of the present disclosure, may be used in an HFC network device, such as an RF amplifier, to communicate directly with other HFC network devices without using a headend or gateway. Embodiments of the transponder may also be used to provide communication using a LoRaWAN® based packet mode and/or a SCTE 25-1 based serial mode.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Embodiments of methods described herein may be implemented using a controller, processor, and/or other programmable device. To that end, methods described herein may be implemented on a tangible, non-transitory computer readable medium having instructions stored thereon that when executed by one or more processors perform the methods. The storage medium may include any type of tangible medium, for example, any type of disk optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. An apparatus for low data rate, low power bidirectional transmissions in a hybrid fiber-coaxial (HFC) network, the apparatus comprising:
a host interface configured to provide an interface with circuitry in a host HFC network device;
a downstream input configured to connect to a downstream signal path in the host network device;
an upstream output configured to connect to an upstream signal path in the host network device;
at least one transceiver coupled to the host interface and coupled to the downstream input and the upstream output; and
a switching system configured to route received signals for the low data rate, low power bidirectional transmissions to the at least one transceiver from either the downstream input or the upstream output and configured to route transmitted signals for the low data rate, low power bidirectional transmissions from the at least one transceiver to either the downstream input or the upstream output.

2. The apparatus of claim 1, wherein the switching system includes two switches connected in series.

3. The apparatus of claim 1, wherein the host interface includes a host connector and a serial communication interface coupling the host connector to the at least one transceiver.

4. The apparatus of claim 3, wherein the serial communication interface is a UART interface.

5. The apparatus of claim 1, wherein the at least one transceiver is configured for low data rate, low power bidirectional transmissions using a LoRaWAN® based packet mode.

6. The apparatus of claim 1, wherein the at least one transceiver is configured for low data rate, low power bidirectional transmissions using a LoRaWAN® based packet mode and an SCTE 25-1 based serial mode.

7. The apparatus of claim 6, further comprising a controller configured to determine whether the LoRaWAN® based packet mode or the SCTE 25-1 based serial mode is used.

8. The apparatus of claim 1, wherein the at least one transceiver includes a first transceiver and a second transceiver, wherein the first transceiver is configured to use at least the SCTE 25-1 based serial mode, and wherein the second transceiver is configured to use at least the LoRaWAN® based packet mode.

9. The apparatus of claim 8, wherein the first transceiver is also configured to use the LoRaWAN® based packet mode.

10. The apparatus of claim 8, wherein the first transceiver is coupled to the second transceiver.

11. The apparatus of claim 10, wherein the first transceiver is coupled to the second transceiver with a serial peripheral interface/general-purpose input/output interface (SPI/GPIO).

12. The apparatus of claim 8, wherein at least one of the first transceiver and the second transceiver include a controller configured to determine whether the LoRaWAN® based packet mode or the SCTE 25-1 based serial mode is used.

13. The apparatus of claim 1, wherein the host interface is configured to provide an interface with amplifier circuitry in a RF amplifier.

14. A system for bi-directional communication in a hybrid fiber-coaxial (HFC) network, comprising:
at least first and second HFC network devices coupled to a coaxial cable distribution network that provides downstream primary signals and upstream primary signals over downstream signal channels and upstream signal channels, respectively, wherein the at least first and second HFC network devices are configured to communicate with each other directly using low data rate, low power bidirectional transmissions, wherein each of the at least first and second HFC network devices includes a transponder comprising:
a host interface configured to provide an interface with HFC network device circuitry;
a downstream input configured to connect to a downstream signal path in the host network device;
an upstream output configured to connect to an upstream signal path in the host network device;
at least one transceiver coupled to the host interface and coupled to the downstream input and the upstream output; and
a switching system configured to route received signals for the low data rate, low power bidirectional transmissions to the at least one transceiver from either the downstream input or the upstream output and configured to route transmitted signals for the low data rate, low power bidirectional transmissions from the at least one transceiver to either the downstream input or the upstream output.

15. The system of claim 14, wherein the HFC network devices include RF amplifiers in the HFC network.

16. The system of claim 15, wherein the host interface includes a host connector coupled to amplifier circuitry and a serial communication interface coupling the host connector to the at least one transceiver.

17. The system of claim 14, wherein the switching system includes two switches connected in series.

18. The system of claim 14, wherein the at least one transceiver includes a first transceiver and a second transceiver, wherein the first transceiver is configured to use at least the SCTE 25-1 based serial mode, and wherein the second transceiver is configured to use at least the LoRaWAN® based packet mode, and wherein the second transceiver is coupled to the switching system.

19. The system of claim 18, wherein the first transceiver is also configured to use the LoRaWAN® based packet mode.

20. An apparatus for low data rate, low power bidirectional transmissions in a hybrid fiber-coaxial (HFC) network, the apparatus comprising:
a host interface configured to provide an interface with circuitry in a host HFC network device;
a downstream input configured to connect to a downstream signal path in the host network device;
an upstream output configured to connect to an upstream signal path in the host network device; and
at least one transceiver coupled to the host interface and coupled to the downstream input and the upstream output, wherein the at least one transceiver is configured for low data rate, low power bidirectional transmissions using a LoRaWAN® based packet mode and an SCTE 25-1 based serial mode.

21. The apparatus of claim 20, wherein the at least one transceiver includes a first transceiver and a second transceiver, wherein the first transceiver is configured to use at least the SCTE 25-1 based serial mode, and wherein the second transceiver is configured to use at least the LoRaWAN® based packet mode.

22. The apparatus of claim 21, wherein the first transceiver is also configured to use the LoRaWAN® based packet mode.

23. The apparatus of claim 21, wherein the first transceiver is coupled to the second transceiver.

24. The apparatus of claim 20, further comprising a controller configured to determine whether the LoRaWAN® based packet mode or the SCTE 25-1 based serial mode is used.
